(19) United States
(12) Patent Application Publication
(10) Pub. No.: US 2023/0311362 A1
(43) Pub. Date: Oct. 5, 2023

(54) ADJUSTABLE INLAY FOR CONCRETE FORM LINER FOR CAST CONCRETE TEXTURES

(71) Applicant: Innovative Brick, LLC, Broomfield, CO (US)

(72) Inventors: William Clare Scott, III, Broomfield, CO (US); Mark A. Scott, Broomfield, CO (US)

(73) Assignee: Innovative Brick Systems, LLC, Broomfield, CO (US)

(21) Appl. No.: 18/188,128

(22) Filed: Mar. 22, 2023

Related U.S. Application Data
(60) Provisional application No. 63/362,244, filed on Mar. 31, 2022.

(51) Int. Cl. B28B 7/36; B28B 11/00; B28B 11/08

(52) U.S. Cl. CPC B28B 7/36; B28B 11/001; B28B 11/08

(57) ABSTRACT

A liner for a form is provided. The form allows for the creation of a precast concrete wall to be formed. The liner allows a building material, for example, brick veneer, to be placed in the liner in a pattern. The pattern is modified by placing an adjustable joint inlay into the liner to form customizable insets for the brick veneer in the precast concrete wall. When liquid concrete is poured into the mold and then hardens, the concrete holds the building material in place in the pattern produced by the liner. The adjustable joint inlay for a precast concrete wall allows insets in a liner to be adjusted to accommodate bricks and stones of varying sizes and to allow the bricks and stones to be arranged in user-customized patterns.

### CROSS-REFERENCE TO RELATED APPLICATIONS

This application claims the benefit of U.S. Provisional Application No. 63/362,244, currently pending, filed Mar. 31, 2022, and titled “FALSE JOINT INLAY FOR MASONRY JOINT IN PRECAST CONCRETE,” the disclosure of which is hereby incorporated herein by reference for all that it teaches and for all purposes.

### SUMMARY

A liner for a form is provided. The form allows for the creation of a precast concrete wall to be formed. The liner allows a building material, for example, brick veneer, to be placed in the liner in a pattern. The pattern may be modified by inserting an adjustable inlay member between preexisting inlay members. When liquid concrete is poured into the mold and then hardens, the concrete holds the building material in place in the pattern produced by the liner and the adjustable inlay.

### BRIEF DESCRIPTION OF THE DRAWINGS

FIG. 1 is a plan view of an adjustable liner for creating a soldier course of bricks, tile, or stone in a cast concrete wall in accordance with embodiments of the present disclosure; other patterns and designs are also possible, for example, wood planking.

FIG. 2 is a perspective view of the adjustable liner for creating a soldier course of bricks, tile, or stone in a cast concrete wall in accordance with embodiments of the present disclosure;

FIG. 3 is a plan view of the adjustable liner, for creating a soldier course of bricks, tile, or stone, coupled or connected to a liner, for a field of bricks, tile, or stone, in a cast concrete wall in accordance with embodiments of the present disclosure;

FIG. 4 is a plan view of the adjustable liner, for creating a soldier course of bricks, tile or stone, coupled or connected to a liner, for a field of bricks, tile, or stone, in a cast concrete wall in accordance with embodiments of the present disclosure;

FIG. 5 is a plan view of the adjustable liner, for creating a soldier course of bricks, tile or stone, coupled or connected to a liner, for a field of bricks, tile, or stone, in a cast concrete wall in accordance with embodiments of the present disclosure; and

FIG. 6 is a process diagram of a method for creating a cast concrete wall having a soldier course of inlaid brick, tile, or stone in accordance with embodiments of the present disclosure.

FIG. 7 is a front view of one example of a liner including adjustable joint inlays for creating a course of bricks or stone in a precast concrete wall in accordance with the principles of the present disclosure;

FIG. 8 is another front view of the liner, showing the adjustable joint inlays in an alternative arrangement and further showing how a adjustable joint inlay can be inserted onto the liner;

FIG. 9 is another front view of the liner, showing the adjustable joint inlays in an alternative arrangement;

FIG. 10A is a perspective view of one example of a adjustable joint inlay for creating a course of bricks or stone in a precast concrete wall accordance with the present disclosure;

FIG. 10B is a front view of the adjustable joint inlay of FIG. 10A, showing a brick positioned next to the adjustable joint inlay during installation;

FIG. 10C is another front view of the adjustable joint inlay of FIG. 10A, showing how the adjustable joint inlay deforms when a brick is inserted onto the liner;

FIG. 10D is a perspective schematic view of the adjustable joint inlay of FIG. 10A, showing the adjustable joint inlay being inserted onto the liner;

FIG. 11 is a schematic cross-section view of a precast concrete wall mold in accordance with the principles of the present disclosure, showing a liner, bricks, adjustable joint inlays, and a layer of concrete;

FIG. 12 is a front view of one example of a adjustable joint inlay for creating a course of bricks or stone in a precast concrete wall accordance with the present disclosure;

FIG. 13 is another front view of the adjustable joint inlay showing two tabs removed from the protrusion of the adjustable joint inlay;

FIG. 14 is a perspective view of one example of a adjustable joint inlay for creating a course of bricks or stone in a precast concrete wall according with the present disclosure;

FIG. 15 is a schematic perspective view of a liner including adjustable joint inlays for creating a course of bricks or stone in a precast concrete wall in accordance with the principles of the present disclosure, showing how the adjustable joint inlay may be attached to the liner;

FIG. 16 is a schematic perspective view of a precast concrete wall showing the liner being removed from the finished wall; and

FIG. 17 is a process diagram of a method for creating a precast concrete wall having inlaid brick or stone in accordance with the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

Pre-cast concrete walls can be formed by pouring liquid concrete into molds. The molds can hold one or more liners. A liner can temporarily hold and position one or more building materials, for example, brick, stone, tile, etc., in a pattern at a face of the precast concrete wall. One liner can create a field of the building material. Other second liners can create other designs, e.g., a soldier course. Additionally or alternatively, the liner that forms the one course can be adjusted or moved in relation to the liner producing the field of building material or other courses to best align the one course in relation to the field or other course.

Further, the liner can be adjusted or customized using an adjustable joint inlay. The adjustable joint inlay can be placed between protrusions in the liner that creates a course of bricks or stone in a precast concrete wall. One configuration of the liner may include a first end, a second end, a first side, a second side, a first face, and a second face. At least one protrusion extends, outwardly from the first face and at some location between the first end and the second end and between the first side and the second side. In configurations, the cross section of the protrusion is bulbous and server to create a gap between the material placed in the liner, where the gap appears as a masonry joint. The can include tabs and a edge profile that allows the adjustable joint inlay to be selectively and adjustably placed anywhere on the liner between two other protrusions in some desired location.

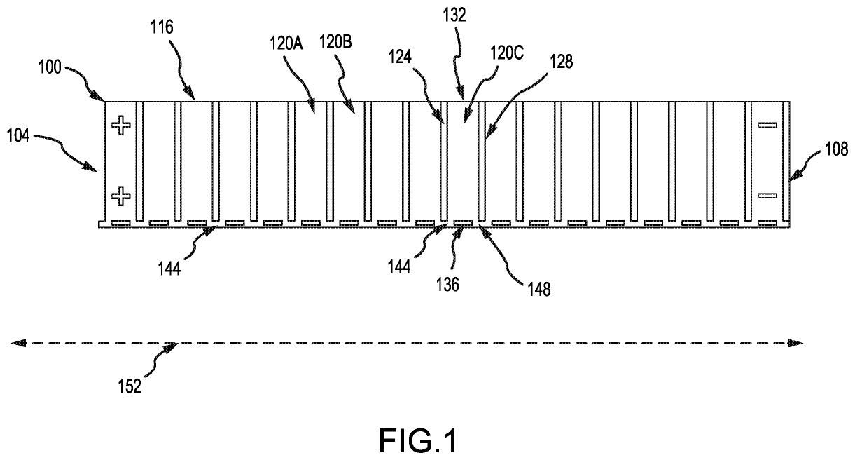

A first example of a liner 100 may be as shown in FIG. 1. The liner 100 can include a first end 104, a second end 108, a first side 112, and a second side 116. A series of insets 120a, 120B, 120C, etc. are created from the first end 104 to the second end 108. The insets 120 can hold parts of a building material, for example, a veneer or thin pieces of brick or stone. The liner 100 may be made similarly to, formed similarly to, and/or function similarly to the liner described in U.S. patent application Ser. No. 11/050,007 and/or U.S. Pat. No. 5,900,180, which are both incorporated by reference herein, for all that they teach and for all purposes.

The insets 120 can be formed by one or more protrusions, formed around a periphery of the insets, which can hold the building material (e.g., brick, tile, or stone) in the inset 120. For example, a first protrusion 124 and second protrusion 128 can hold a brick, tile, or stone along a lengthwise axis. A third protrusion 136 may hold the brick, tile, or stone along a width-wise axis. The fourth side 132 of the inset 120 may not include a protrusion for easier coupling, connecting, and/or mating of the liner 100 with other liners that may form the field of brick, tile, or stone in the precast concrete wall.

The third protrusion 136 may not extend from the first protrusion 124 to the second protrusion 128. Rather, a first space 144 may be created between the third protrusion 136 and the first protrusion 124, and a second space 148 may be created between the third protrusion 136 and the second protrusion 128. The third protrusion 136 can mate, connect, or couple with a similar protrusion on another liner that may form the field of brick, tile, or stone, for example, a liner that creates the field of brick, tile, or stone.

The liner 100 may be adjustable. The liner 100 can be moved along axis 152 in either direction along the axis 152. The movement may be made even if the liner 100 is coupled to other liners on the first side 112 or second side 116. In this way, the soldier course can be adjusted to better fit over window openings, door openings, or create unique and random patterns or configurations. The adjustability ensures that small fragments of brick, tile, or stone will not be needed in the field at the location of the first end 104 or second end 108 of the liner 100 where the field meets the soldier course. The first space 144 and second space 148 allow for easier movement of the liner 100 because there is less friction between the protrusion 136 and the protrusion of the mating liner.

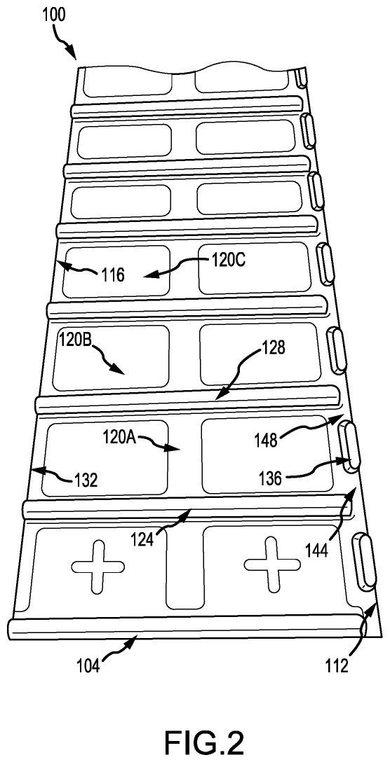

A perspective view of the liner 100 may be as shown in FIG. 2. From this view, the protrusions 136, 124, and 128 are better shown. The protrusions 136, 124, and 128 can be of various depths depending on the thickness of the brick, tile, or stone to be laid in the insets 120 and the amount of reveal for the finished “grout line” that is created by the protrusions 136, 124, and 128. The cross section of the protrusions 124, 128, 136 may be of any shape, for example, a semi-circle. The width and length of the insets 120 may also change based on the length and width of the brick, tile, or stone to be placed in the inset 120. Still further, the overall length and/or width of the liner 100 may change based on the length and width of the brick or stone to be placed in the insets 120 and on the width of the opening or the configuration of the soldier course. In some configurations, two or more liners 100 can be connected, mated, and/or coupled together to create longer runs of brick, tile, or stone.

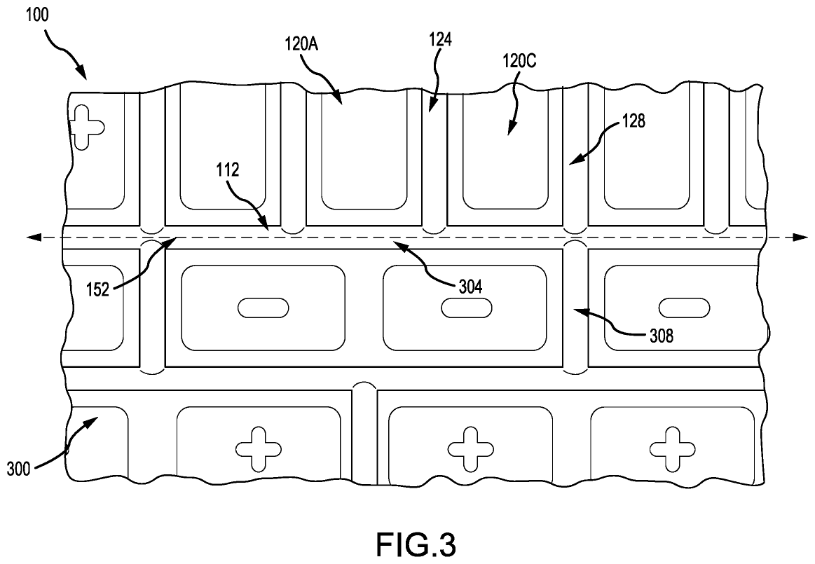

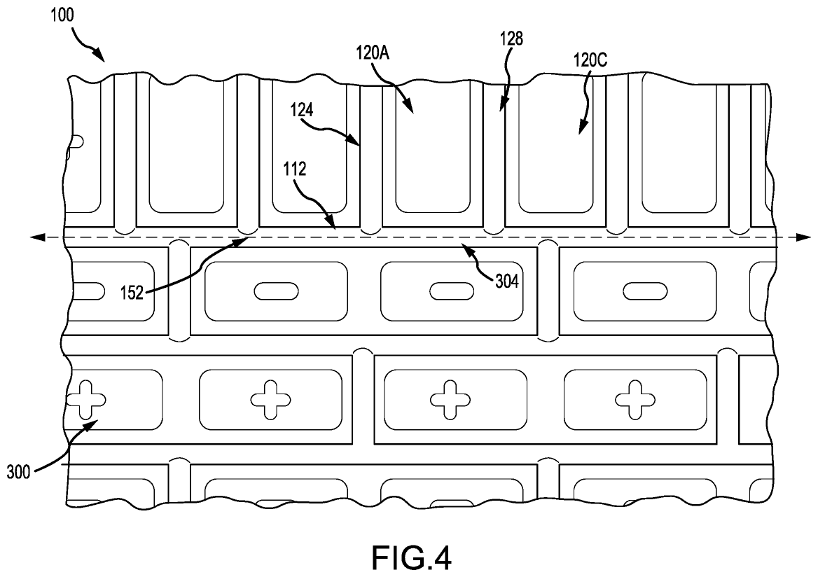

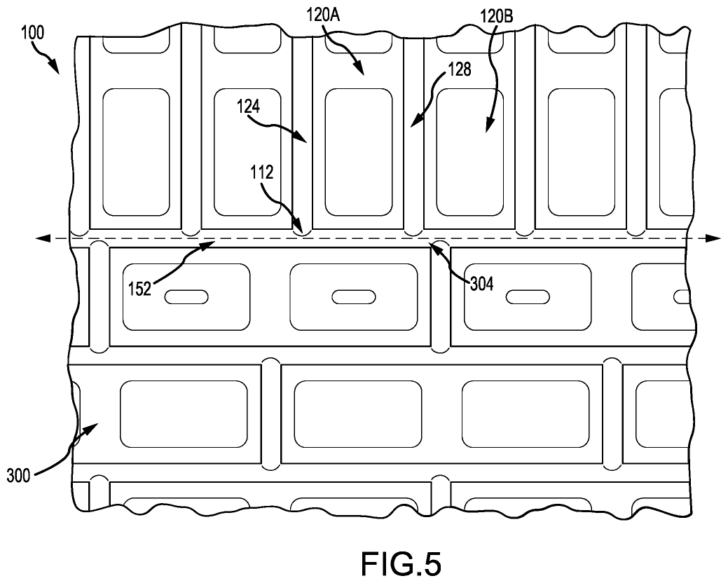

FIGS. 3, 4, & 5 show different configurations of the liner 100 when mated, coupled, and/or connected to the liner 300, which creates the field of brick, tile, or stone. In at least some configurations, the protrusion 136 is placed under and inserted into the rear of the protrusion 304 of the liner 300. The liner 100 may then be moved in either direction along axis 152 to align the soldier course as desired. For example, in FIG. 3, the protrusion 128 of the liner 100 may be aligned with protrusion 308 of the liner 300 to imitate a continuous “grout line” in the final wall. Other alignments are possible, for example, the liner 100 may be moved along axis 152 to create the alignments shown in FIGS. 4 and 5.

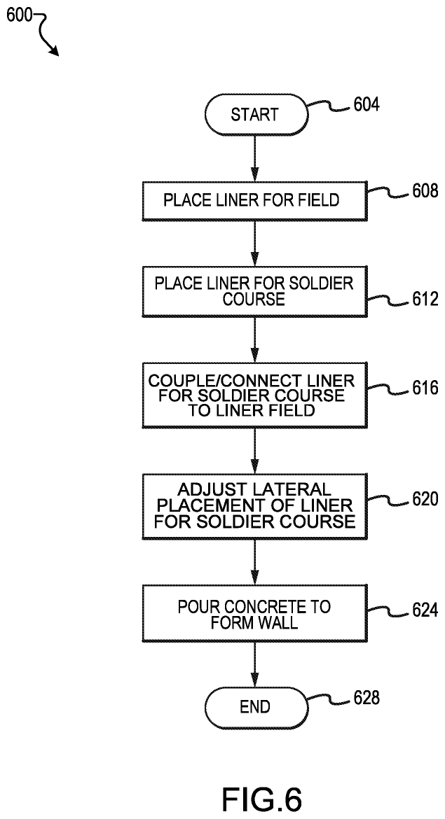

A method 600 for creating a wall with inset brick, tile, or stone using the liner 100 may be as shown in FIG. 6. The method 600 can start with a start operation 604 and end with an end operation 628. As a possible first step, a liner 300 for the field of brick or stone may be placed in a mold for a cast concrete wall, in step 608. The liner 300 may be placed at the bottom of the mold before the liquid concrete is poured into the mold. Two or more liners 300 may be placed in the mold.

A liner 100 for the soldier course may then be placed in the mold, in step 612. The liner 100 can be placed along a top or a bottom of a window opening or door opening, along an area that will have a decorative run of brick or stone configured as a soldier course, and/or at other locations depending upon the configuration of the brick, tile, or stone desired for the wall.

The liner 100 may then be coupled, connected, and/or mated with liner 300, in step 616. Thus, the protrusion 136 may be inserted into a rear of a protrusion 304 at a top side (or bottom side) of the liner 300. This mating of the protrusion 136, with protrusion 304, in general, physically connects the liners 100, 300. However, the liner 100 can still move in relation to liner 300 by sliding the liner 100 along axis 152.

In step 620, the liner 100 is slid into position laterally along axis 152. The final position of the liner 100, in relation to liner 300, may be based on the location of the opening or decorative course of brick, tile, or stone. Further, the location of the liner 100 may be adjusted to ensure that no small fragment of brick, tile, or stone are placed next to the soldier course at the first end 104 and/or the second end 108. Thus, the soldier course is adjustable and can be configured as desired by moving the liner 100 along axis 152.

After or while placing all the required liners 100, 300 in the mold, brick, tile, or stone may be inserted into the various insets 120 of the liner 100 and/or liner 300. Once the brick or stone is placed in the mold, liquid concrete may be poured into the mold to form the wall, in step 624. The concrete can flow around the inserted brick, tile, or stone and generally take the shape of the protrusions 124, 128, 304. Once the concrete has hardened, the brick, tile, or stone are held in place by the concrete, and the mold may be removed to expose the liners 100, 300. The liners 100, 300 may then be removed from the brick, tile, or stone to reveal the face of the wall with the brick, tile, or stone embedded in the hardened concrete and in the pattern as created by the liners 100, 300.

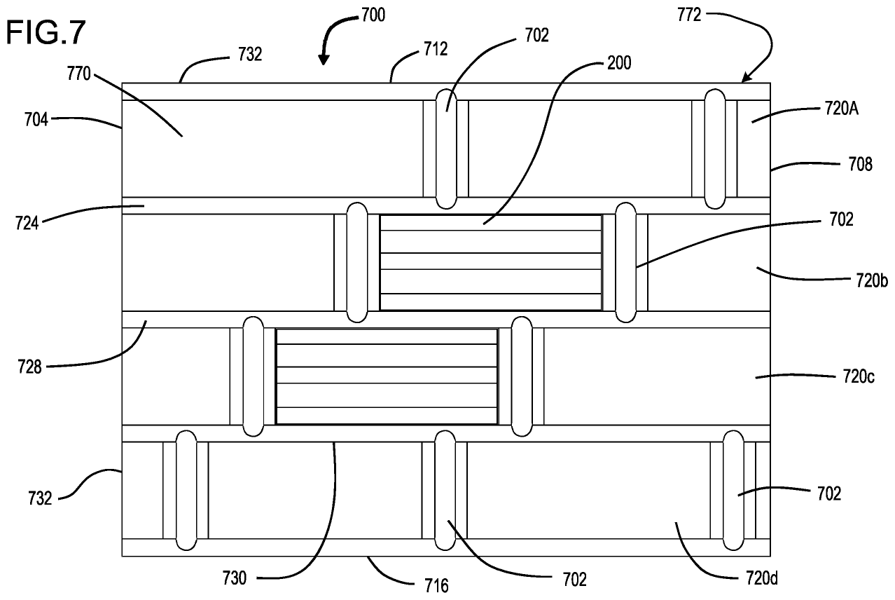

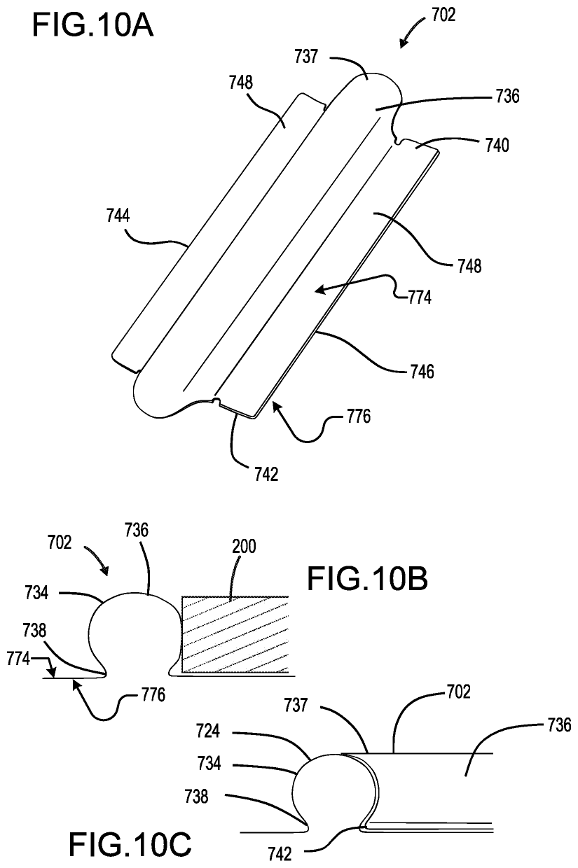

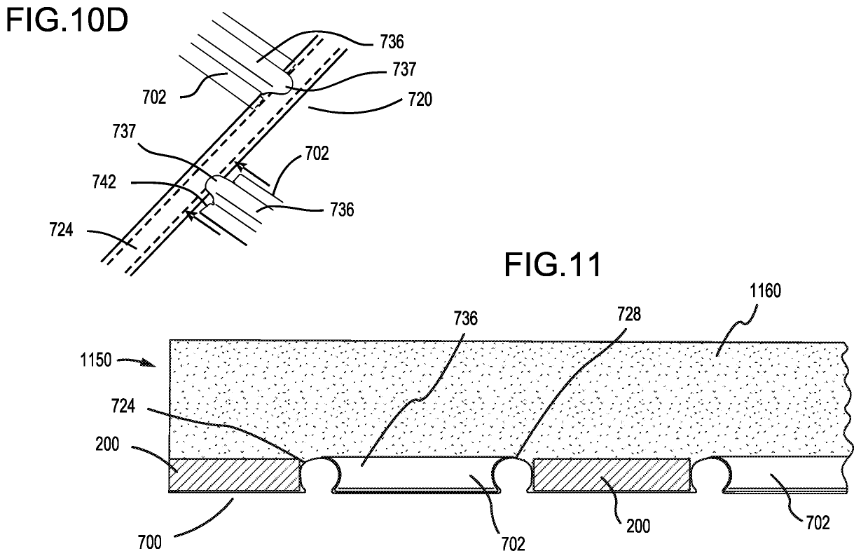

Another example of a liner 700 including an adjustable joint inlay 702 (also referred to as a removable false joint) in accordance with aspects of this disclosure is shown in FIG. 7. Liner 700 provides a surface on which to insert bricks 200 in a desired pattern to lay in a mold 1150 prior to filling the mold with concrete 1160. In at least some examples, liner 700 is a substantially flat sheet of flexible material, as explained herein, although rigid materials may alternatively be used. Liner 700 may also include at least one protrusion 724, 728, 730, as explained above, that extends across the liner 700 in any of one or more directions. As shown, the protrusions 724, 728, 730 have cross-sectional profiles that are generally bulbous (e.g., mushroom shaped), e.g., a distal portion (e.g., a head) 734 larger than a proximal portion (e.g., a stem) 738. One example of this cross-sectional profile is shown in FIGS. 10B, 10C, and 11.

The liner 700 can hold a veneer of different types of materials, e.g., tile, stone, brick, etc. Hereinafter, only for explanation purposes, the liner 700 is described as holding a veneer of brick, but the configurations are not limited to that specific type of veneer. The adjustable joint inlay 702 can form a perp joint, the vertical joints between bricks 200 that are laid in a horizontal course in a simulated brick wall. The protrusion 736 may hold the brick 200, in the liner 700, along a width-wise axis of the brick. The liner 700 can include a first liner end 704, a second liner end 708, a first liner side 712, and a second liner side 716. Further, the liner 700 can include a first liner face 770 and a second liner face 772. In certain examples, a series of insets 720a, 720b, 720c, 720d etc. are created from the first liner end 704 to the second liner end 708 by the protrusions 724, 728, 730 that protrude from the first liner face 770. The insets 720 can hold thin pieces of brick 200. In certain examples, brick 200 may be replaced by tile, stone, or other types of veneer.

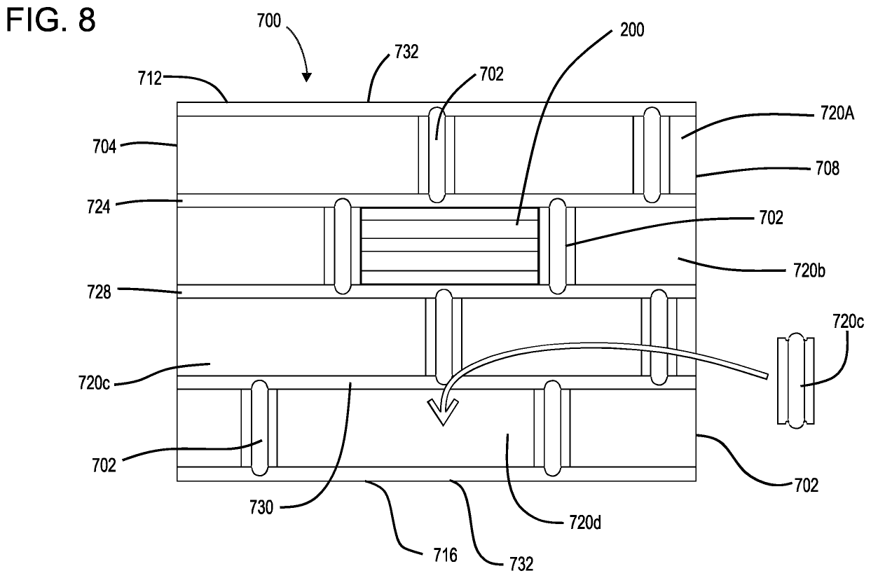

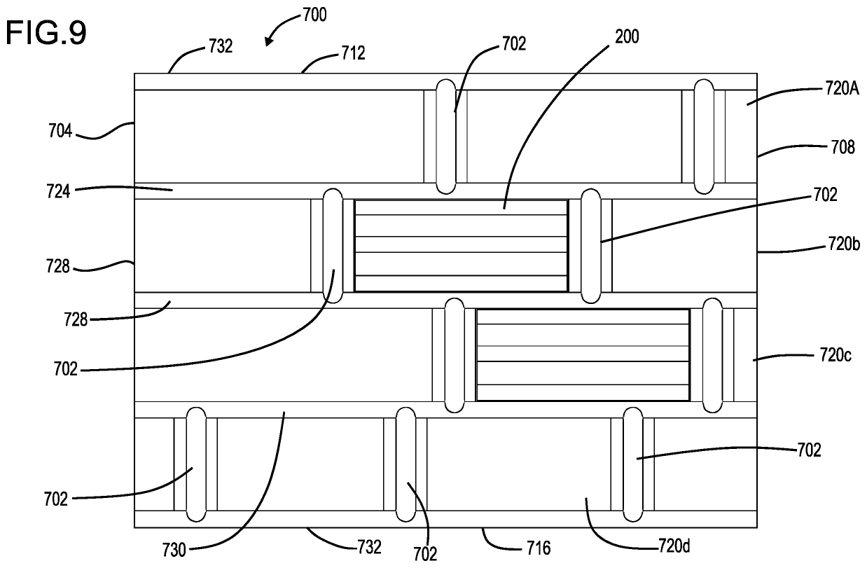

As shown in FIGS. 7-9, the insets 720 can be formed by combining one or more of the protrusions 724, 728, 730 with one or more adjustable joint inlays 702 that can surround and hold the brick 200 in the inset 720. The adjustable joint inlays 702 are separate components that are removably attached to the liner 700. In examples, the integrated protrusions 724, 728, 730 are integrally formed in liner 700. The protrusions 724, 728, 730 may be formed by heating the liner 700 material and then molding a cavity into the second liner face 772, which also produces the protrusions 724, 728, 730 in the first liner face 770.

A first protrusion 724 and second protrusion 728, integrated into the liner 700, can hold a brick 200 along a lengthwise axis. As shown, a plurality of adjustable joint inlays 702 may be inserted into the liner 700. The adjustable joint inlay 702 may be positioned and extended between first protrusion 724 and second protrusion 728. Additional adjustable joint inlays 702 are shown inserted into and distributed across the liner 700 to create a desired pattern of bricks 200. An outside edge 732 of liner 700 may include features for easier coupling, connecting, and/or mating of another liner with additional liners that together may form the veneer of brick 200 in a precast concrete wall.

The adjustable joint inlay 702 may be attached to liner 700 in any suitable location, allowing for maximum flexibility with regard to brick patterns. In this way, liner 700 can be configured to form the field, window openings, door openings, or other configurations. The adjustability and customizability of the adjustable joint inlay 702 ensures that smaller pieces of brick or stone may not be needed in the field at the location of the first liner end 704 or second liner end 708 of the liner 700 where the field meets another precast section. For example, full-length pieces of brick may be used at the first liner end 704 or second liner end 708 of the liner 700 to interleave with and end of another precast wall section.

One example of an adjustable joint inlay 702 may be as shown in FIGS. 10A-10D. The adjustable joint inlay 702 can include a first end 740, a second end 742, a first side 744, a second side 746, a first face 774, and a second face 776. As shown, the adjustable joint inlay 702 can include an adjustable protrusion 736 that extends from the first face 774, between the first end 740 and the second end 742, and is positioned between the first side 744 and second side 746. As shown in FIGS. 10B and 10C, the adjustable protrusion 736 can be contoured like protrusions 724, 728, 730 to form a simulated masonry joint and has a similar bulbous cross-sectional profile to protrusions 724, 728, 730. Like the protrusions 724, 728, 730, adjustable protrusion 736 has a distal portion 734 that is larger than the proximal 738. Further, the shape of the adjustable protrusion 736 can contact and hold the brick in the inset formed by the adjustable joint inlay 702. After pouring concrete in the mold, the adjustable protrusion 736 can create an apparent masonry joint (e.g., a simulated masonry joint formed in the concrete) between the bricks 200.

As shown in FIGS. 10B and 11, in at least some examples, protrusions 736, 724, 728, 730 are made of a semi-flexible, resilient material that can deform slightly upon insertion of bricks 200 into an inset 720 of the liner 700. The deformation of adjustable protrusion 736 provides a mechanical holding force that can maintain or secure the bricks 200 in the inset 720 of liner 700. The material of the protrusions 736, 724, 728, 730 can use friction to hold the brick 200 and can create at least a partial seal between the protrusions 736, 724, 728, 730 and the bricks. This minimizes or eliminates the flow of concrete 1160 under the bricks 200 when the mold 1150 is filled.

As shown in FIGS. 10A and 10C, the adjustable joint inlay 702 optionally includes an end profile (which optionally includes flanges 737) that is formed along the adjustable protrusion 736 at the distal first end 740 and/or the distal second end 742. The end profile contacts the protrusion 724. When attached to the liner 700, flanges 737 extend at least partially over integrated protrusions 724, 728, 730 and selectively engage with the distal portion 734. The end profile can also engage the proximal portion 738 of the protrusions 724, 728, 730, possibly including the portion of the protrusions 724, 728, 730 between sections 734 and 738. The shape of end profile at the ends 740, 742 and flanges 737 mimics or substantially matches the cross-sectional shape of the protrusions 724, 728, 730. The end profile substantially matches the cross-sectional shape of the protrusions 724, 728, 730 if the gap between the end profile and protrusion is less than 5 mm. The cross-sectional profile and end profile of the adjustable joint inlay 702 can create a mortar joint at the corners of bricks 200 or stone by extending the flanges 737 at least partially over protrusions 724, 728, 730. Thus, the adjustable joint inlay 702 generates the desired illusion of a continuous “grout line” in the precast concrete wall 1600, after the wall 1600 is removed from the mold 1150.

The adjustable joint inlay 702 may further include two tabs 748 that extend from the adjustable protrusion 736 and the first and second sides 744, 746. When adjustable joint inlay 702 is installed in liner 700, and bricks 200 are inserted into insets 720, the tabs 748 are positioned between the bricks 200 and the liner 700, thereby securing the adjustable joint inlay 702 in position. In examples, adjustable protrusion 736 may include alternative contours to create masonry joints of various sizes and shapes. For example, protrusions 736 can be of various depths depending on the thickness of the brick or stone to be laid in the insets 720 and the amount of reveal for the finished “grout line” that is created by the adjustable protrusion 736. The width and length of the insets 720 may also change based on the length and width of the brick or stone to be placed in the inset 720. Still further, the overall length and/or width of the liner 700 may change based on the length and width of the brick or stone to be placed in the insets 720, on the desired pattern of bricks or stone, and on the size of the finished wall. In some examples, two or more liners 700 can be connected, mated, and/or coupled together to create longer runs of veneer.

FIGS. 7-9 further show different configurations of the liner 700 with a plurality of adjustable joint inlays 702 positioned between integrated protrusions 724, 728, 730. Positioning bricks 200 in the insets 720 creates the field of brick. The adjustable joint inlay 702 may be moved to align the bricks 200 as desired in any desired customized pattern. In other words, the adjustable joint inlay 702 can be inserted between integrated protrusions 724, 728, 730 and is slidable along the gap formed between those integrated protrusions 724, 728, 730.

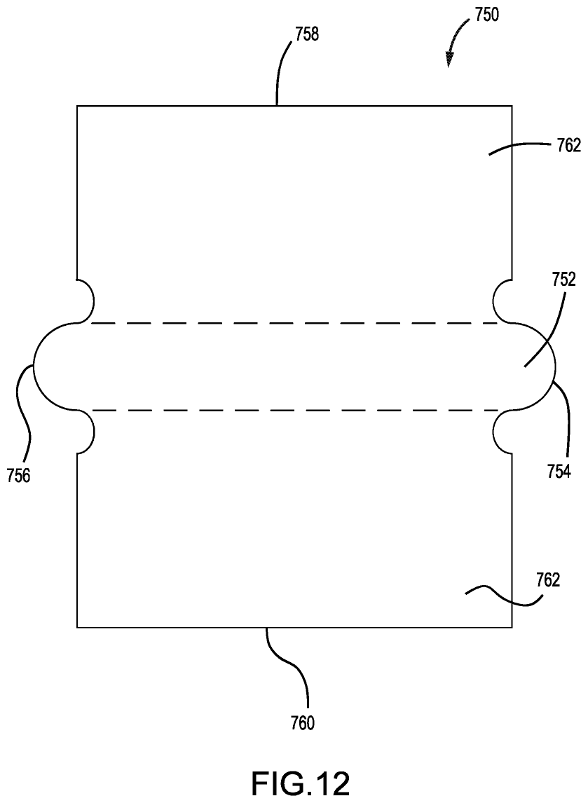

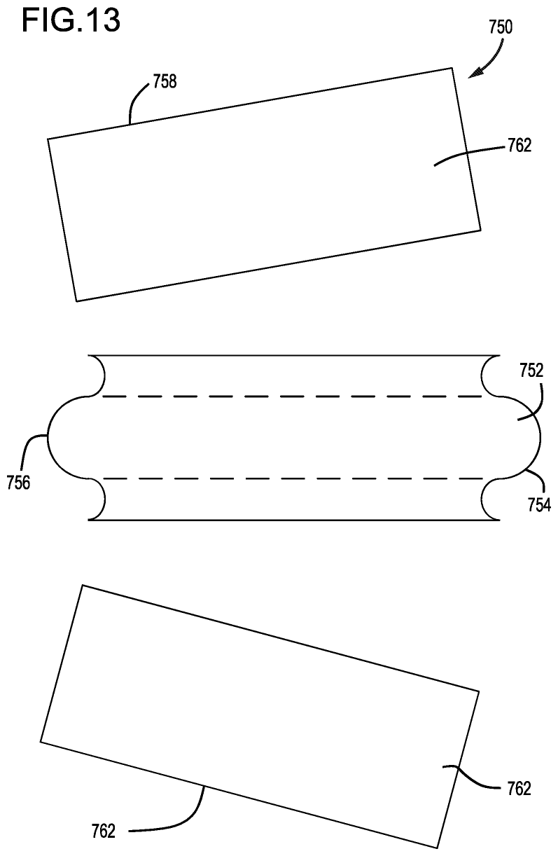

FIGS. 12 and 13 show alternative examples of another adjustable joint inlay 750 in accordance with the aspects of this disclosure. Adjustable joint inlay 750 can include a first end 754, a second end 756, a first side 758, and a second side 760. As shown, adjustable joint inlay 750 includes a protrusion 752 that extends between the first end 754 and the second end 756 and is positioned between the first side 758 and second side 760. Adjustable joint inlay 750 can further include two tabs 762 that extend from the protrusion 752 and to the first and second sides 758, 760. In the example shown, tabs 762 may be detached from adjustable joint inlay 750, which allows the protrusion 752 to be positioned adjacent to an edge 732 of the liner 700, which may also correspond to the edge of the mold 1150, thereby allowing a joint to be positioned at the edge.

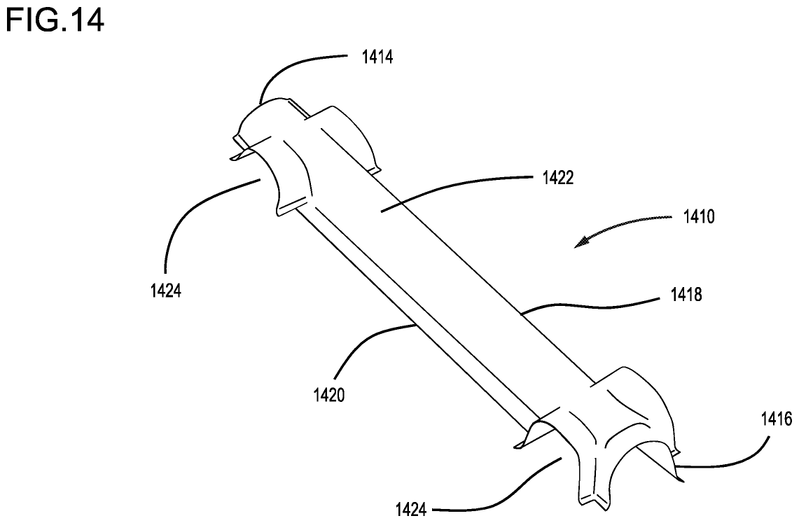

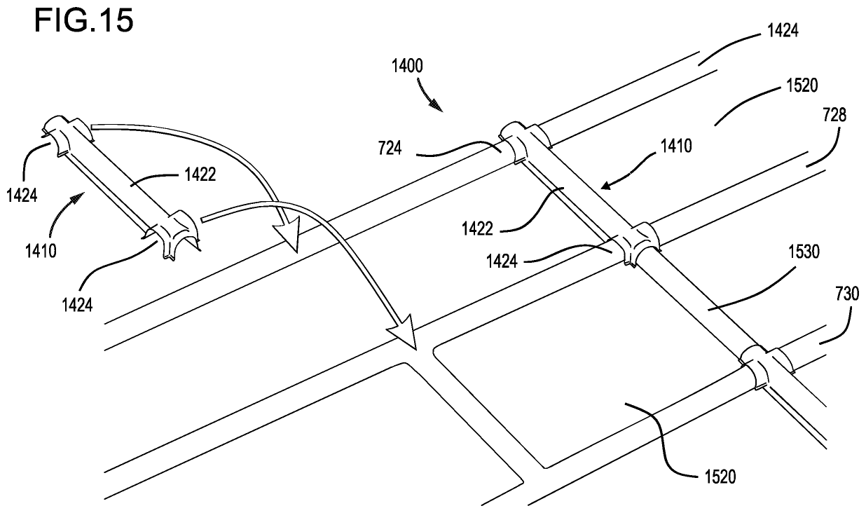

FIGS. 14 and 15 show another alternative example 1400 of another adjustable joint inlay 1410 placed in a liner 700 in accordance with aspects of this disclosure. As shown, adjustable joint inlay 1410 includes a first end 1414, a second end 1416, a first side 1418, and a second side 1420. As shown, adjustable joint inlay 1410 includes a protrusion 1422 that extends between the first end 1414 and the second end 1416 and is positioned between the first side 1418 and second side 1420. Adjustable joint inlay 1410 further includes two joint pathways 1424 positioned along the length of protrusion 1422 and define a path through which an integrated protrusion 724, 728, 730 can extend. The joint pathways 1424 are shaped such that the adjustable joint inlay 1410 can selectively engage the protrusions 724, 728, 730, where the protrusions 724, 728, 730 meet, when the protrusion 736 is attached to the liner 700. As shown in FIG. 15, protrusion 1422 extends past the joint pathways 1424 and may engage a protrusion 1530 that is substantially parallel (less than 10° deflection between protrusions) to protrusion 1422 and extends between integrated protrusions 724, 728, 730. In examples, adjustable joint inlay 1410 may include only one joint pathway 1424 without departing from the principles of this disclosure. The protrusions 724, 728, 730 and the adjustable joint inlay 1410 can form inset(s) 1520.

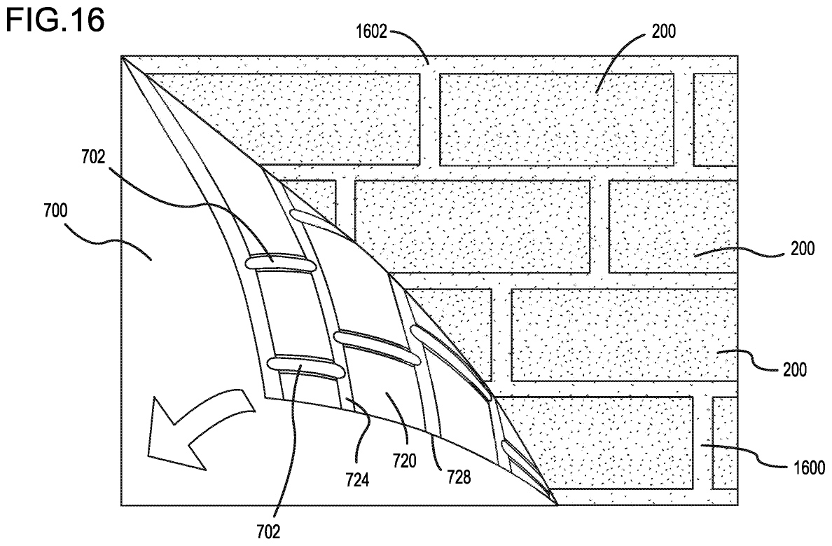

FIG. 16 shows a schematic view of liner 700 being removed from a finished precast concrete wall 1600, an article of manufacture. As shown, when the concrete 1160 has set and the precast concrete wall 1600 is removed from the mold 1150, liner 700 may be removed (e.g., peeled away) from the precast concrete wall 1600 to reveal the veneer of bricks in the desired arrangement, with faux-mortar joints 1602 between the bricks. The liner 700 may then be cleaned and reused, with the adjustable joint inlays 702, 750, 1410 repositioned as desired.

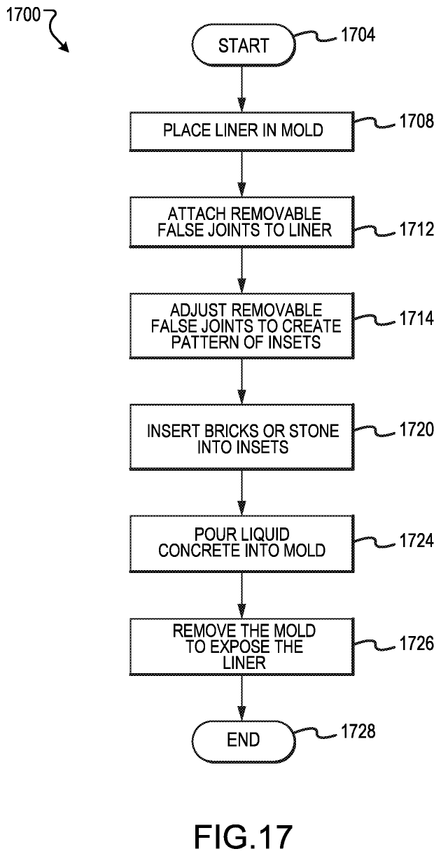

A method 1700 for creating a wall with inset brick or stone using the liner 700 and adjustable joint inlays 702 may be as shown in FIG. 17. The method 1700 can start with a start operation 1704 and end with an end operation 1728. As a possible first operation, a liner 700 for a field of brick or stone may be placed in a mold 1150 for a precast concrete wall, in operation 1708. The liner 700 may be placed at the bottom of the mold 1150 before liquid concrete 1160 is poured into the mold 1150. In certain examples, two or more liners 700 may be placed in the mold at the same time.

A plurality of adjustable joint inlays 702 may then be placed in the mold 1150, in operation 1712. The adjustable joint inlays 702 can be placed as desired to form a run of brick 200 or stone in a pattern desired for the wall. The adjustable joint inlays 702 may be positioned between protrusions 724, 728, 730 that are formed or molded in the liner 700. Until the liner is filled with bricks 200, adjustable joint inlays 702 can be repositioned as desired in relation to liner 700. For example, the positioning of adjustable joint inlays 702 may be customized to ensure that no small fragments of brick 200 or stone must be included where they are undesired. Further, adjusting the positioning of adjustable joint inlays 702, in operation 1714, allows a variety of desired patterns to be included in a wall panel without the need for creating unique liners for each desired pattern.

After or while placing all the required adjustable joint inlays 702 in the liner 700, bricks 200 may be inserted into the various insets 720 formed by the protrusions 724, 728, 730 and the adjustable joint inlays 702, in operation 1720. Once the bricks 200 are placed in the liner 700 and mold 1150, liquid concrete 1160 may be poured into the mold 1150 to form the wall, in operation 1724. The concrete can flow around the inserted brick or stone and generally take the shape of the protrusions 724, 728, 730 and adjustable joint inlays 702. Once the concrete 1160 has hardened, the bricks are held in place by the concrete, and the mold 1150 may be removed to expose the liner 700. The liner 700 may then be removed from the brick or stone, in operation 1726, to reveal the face of the wall with the brick or stone embedded in the hardened concrete and in the pattern as created by the protrusions 724, 728, 730 and the adjustable joint inlay(s) 702.

The exemplary systems and methods of this disclosure have been described in relation to an adjustable liner for creating a soldier course of brick, tile, or stone in a precast concrete wall. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Also, while the flowcharts have been discussed and illustrated in relation to a particular sequence of events, it should be appreciated that changes, additions, and omissions to this sequence can occur without materially affecting the operation of the disclosed examples, configuration, and aspects.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The present disclosure, in various aspects, examples, and/or configurations, includes components, methods, processes, systems and/or apparatus substantially as depicted and described herein, including various aspects, examples, configurations examples, subcombinations, and/or subsets thereof. Those of skill in the art will understand how to make and use the disclosed aspects, examples, and/or configurations after understanding the present disclosure. The present disclosure, in various aspects, examples, and/or configurations, includes providing devices and processes in the absence of items not depicted and/or described herein or in various aspects, examples, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, examples, and/or configurations for the purpose of streamlining the disclosure. The features of the aspects, examples, and/or configurations of the disclosure may be combined in alternate aspects, examples, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, example, and/or configuration. Thus, the following claims are hereby incorporated into this Detailed Description, with each claim standing on its own as a separate preferred example of the disclosure.

Moreover, though the description has included description of one or more aspects, examples, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, examples, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An adjustable joint inlay comprising:
a first end that contacts a first protrusion of a liner;
a second end that contacts a second protrusion of the liner, the contacts with the first protrusion and second protrusion hold the adjustable joint inlay in position in the liner; and
an adjustable protrusion extending from a first face of the adjustable joint inlay.

2. The adjustable joint inlay of claim 1, the adjustable protrusion having a contour at a distal end of the adjustable protrusion, the contour creates an apparent masonry joint with concrete is poured over the liner.

3. The adjustable joint inlay joint of claim 2, further comprising a first side and a second side.

4. The adjustable joint inlay joint of claim 3, further comprising a first tab extending from a first side and a second tab extending from the second side.

5. The adjustable joint inlay joint of claim 4, the first tab and/or second tab are removable.

6. The adjustable joint inlay joint of claim 4, the first tab and/or second tab are positioned under an inlay when the inlay is inserted into an inset created by the first protrusion, second protrusion and the adjustable protrusion.

7. The adjustable joint inlay joint of claim 6, the inlay being one of tile, stone, or brick.

8. The adjustable joint inlay joint of claim 7, the first end having an end profile that substantially matches a protrusion profile of the first protrusion.

9. The adjustable joint inlay joint of claim 8, a mating of the end profile and the protrusion profile hold the adjustable joint inlay in the position in the liner.

10. The adjustable joint inlay joint of claim 2, the adjustable joint inlay is slidable along a gap formed between the first protrusion and second protrusion.

11. A liner comprising:
a liner first end;
a liner second end;
a liner first side;
a liner second side;
a liner first face;
a liner second face;
a first protrusion extending outward from the liner first face and located from the liner first end to the liner second end;
a second protrusion extending outward from the liner first face and located from the liner first end to the liner second end, the second protrusion substantially parallel to the first protrusion and forming a gap between the first protrusion and the second protrusion;
an adjustable joint inlay comprising:
a first end that contacts the first protrusion of the liner;
a second end that contacts the second protrusion of the liner, the contacts with the first protrusion and second protrusion hold the adjustable joint inlay in position in the liner; and
an adjustable protrusion extending from a first face of the adjustable joint inlay.

12. The liner of claim 11, the adjustable protrusion having a contour at a distal end of the adjustable protrusion, the contour creates an apparent masonry joint with concrete is poured over the liner.

13. The liner of claim 11, the first end having an end profile that substantially matches a protrusion profile of the first protrusion.

14. The liner of claim 13, a mating of the end profile and the protrusion profile hold the adjustable joint inlay in the position in the liner.

15. The liner of claim 11, the adjustable joint inlay is slidable along the gap formed between the first protrusion and second protrusion.

16. A method for creating a precast concrete wall with a veneer of brick or stone, the method comprising;
placing a liner, for creating a field of brick or stone veneer on a first face of the precast concrete wall, into a mold that forms the precast concrete wall;
the liner including two or more protrusions;
inserting a first adjustable joint inlay into the liner between two of the two or more protrusions in a first location;
inserting a second adjustable joint inlay into the liner between two of the two or more protrusions in a second location;
adjusting the first location of the first adjustable joint inlay to create a pattern of insets that hold the veneer;
inserting the bricks or stone into the insets to create the field;
pouring liquid concrete into the mold;
after the liquid concrete hardens, removing the mold to expose the liner; and
removing the liner to expose the veneer of brick or stone.

17. The method of claim 16, further comprising: mating a profile of the first adjustable joint inlay with a profile of one of the two or more protrusions.

18. The method of claim 17, adjusting the first location comprises sliding the first adjustable joint inlay along a gap between two of the protrusions.

19. The method of claim 16, the two or more protrusions and the adjustable joint inlay create two or more simulated mortar joints between the veneer.

20. An article of manufacture created by a method for creating a precast concrete wall with a veneer of brick, tile, and/or stone, the method comprising;
placing a liner, for creating a field of brick or stone veneer on a first face of the precast concrete wall, into a mold that forms the precast concrete wall;
the liner including two or more protrusions;
inserting a first adjustable joint inlay into the liner between two of the two or more protrusions in a first location;
inserting a second adjustable joint inlay into the liner between two of the two or more protrusions in a second location;
adjusting the first location of the first adjustable joint inlay to create a pattern of insets that hold the veneer;
inserting the bricks or stone into the insets to create the field;
pouring liquid concrete into the mold;
after the liquid concrete hardens, removing the mold to expose the liner; and
removing the liner to expose the veneer of brick or stone.
